(19) United States
(12) Patent Application Publication
(10) Pub. No.: US 2025/0262650 A1
(43) Pub. Date: Aug. 21, 2025

(54) DESCALE TANK FOR STAND-ALONE ICE MAKING APPLIANCE

(71) Applicant: Haier US Appliance Solutions, Inc., Wilmington, DE (US)

(72) Inventors: Srikanth Raavi Venkata, Louisville, KY (US); Ronald Scott Tarr, Louisville, KY (US); Samuel Vincent DuPlessis, Louisville, KY (US)

(21) Appl. No.: 18/442,697

(22) Filed: Feb. 15, 2024

(51) Int. Cl. B08B 9/08; F25C 1/00

(52) U.S. Cl. CPC B08B 9/08; F25C 1/00; B08B 2209/08; F25C 2400/12

(57) ABSTRACT

A cleaning vessel is configured to fluidly couple to a stand-alone ice making appliance. The cleaning vessel includes a casing and a user interface on the casing. The cleaning vessel also includes a pump and a plurality of tanks disposed within the casing. A fluid port is on the casing and is fluidly coupled to the plurality of tanks. A controller is also disposed within the casing. The controller is configured to operate the pump to drain a first fluid from the stand-alone ice making appliance into a first tank of the plurality of tanks of the cleaning vessel. The controller is also configured to operate the pump to pump a second fluid from a second tank of the plurality of tanks of the cleaning vessel into the stand-alone ice making appliance.

### FIELD OF THE INVENTION

The present subject matter relates generally to ice making appliances, and more particularly to systems and methods for descaling components of stand-alone ice making appliances.

### BACKGROUND OF THE INVENTION

Ice makers generally produce ice for use by consumers, such as in beverages, for cooling food items, etc. Certain refrigerator appliances include ice makers for producing ice. The ice maker can be positioned within the appliance's freezer chamber and direct ice into an ice bucket where the ice is stored within the freezer chamber. Such refrigerator appliances can also include a dispensing system for assisting a user with accessing ice produced by the refrigerator appliance's ice maker. However, the incorporation of ice makers into refrigerator appliances can have drawbacks, such as limits on the amount of ice that can be produced and the reliance on the refrigeration system of the refrigerator appliance to form the ice.

Stand-alone ice makers are separate from refrigerator appliances and provide independent ice supplies. Generally, liquid water is added to the stand-alone ice makers, and the ice makers operate to freeze the liquid water and form ice. Users frequently add tap water to the stand-alone ice makers. Tap water may include various impurities that negatively affect the appearance and/or taste of ice cubes formed from the tap water. Further, tap water may, over time, lead to scale buildup within the ice maker.

Traditional methods of cleaning some ice makers may include moving the whole ice machine closer to a sink or use a big bucket to drain the water used to clean and rinse, which is manually intensive. Accordingly, a system for cleaning an ice maker that removes the manual intensity of traditional methods would be advantageous.

### BRIEF DESCRIPTION OF THE INVENTION

Aspects and advantages of the invention will be set forth in part in the following description, or may be obvious from the description, or may be learned through practice of the invention.

In one example embodiment, a cleaning vessel is provided. The cleaning vessel is configured to fluidly couple to a stand-alone ice making appliance. The cleaning vessel includes a casing and a user interface on the casing. The cleaning vessel also includes a pump and a plurality of tanks disposed within the casing. A fluid port is on the casing and is fluidly coupled to the plurality of tanks. A controller is also disposed within the casing. The controller is configured to operate the pump to drain a first fluid from the stand-alone ice making appliance into a first tank of the plurality of tanks of the cleaning vessel. The controller is also configured to operate the pump to pump a second fluid from a second tank of the plurality of tanks of the cleaning vessel into the stand-alone ice making appliance.

In another example embodiment, a method for operating a cleaning vessel is provided. The cleaning vessel is configured to fluidly couple to a stand-alone ice making appliance. The cleaning vessel includes a casing, a user interface on the casing, and a pump disposed within the casing. The cleaning vessel also includes a plurality of tanks within the casing and a fluid port on the casing. The fluid port is fluidly coupled to the plurality of tanks. A controller is also included in the cleaning vessel, disposed within the casing. The method includes operating the pump to drain a first fluid from the stand-alone ice making appliance into a first tank of the plurality of tanks of the cleaning vessel. The method also includes operating the pump to pump a second fluid from a second tank of the plurality of tanks of the cleaning vessel into the stand-alone ice making appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of an appliance according to an example embodiment of the present disclosure.

FIG. 2 is a perspective section view of the example appliance of FIG. 1.

FIG. 3 is a rear perspective view of the example appliance of FIG. 1 with a casing of the example appliance removed to show interior components of the example appliance.

FIG. 4 is a perspective view of the example auxiliary reservoir in FIG. 1.

FIG. 5 is a perspective view of an example cleaning vessel according to aspects of the present disclosure.

FIG. 6 is a side, schematic view of the example cleaning vessel of FIG. 5.

FIG. 7 provides a flowchart of an example method of operating a cleaning vessel according to aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

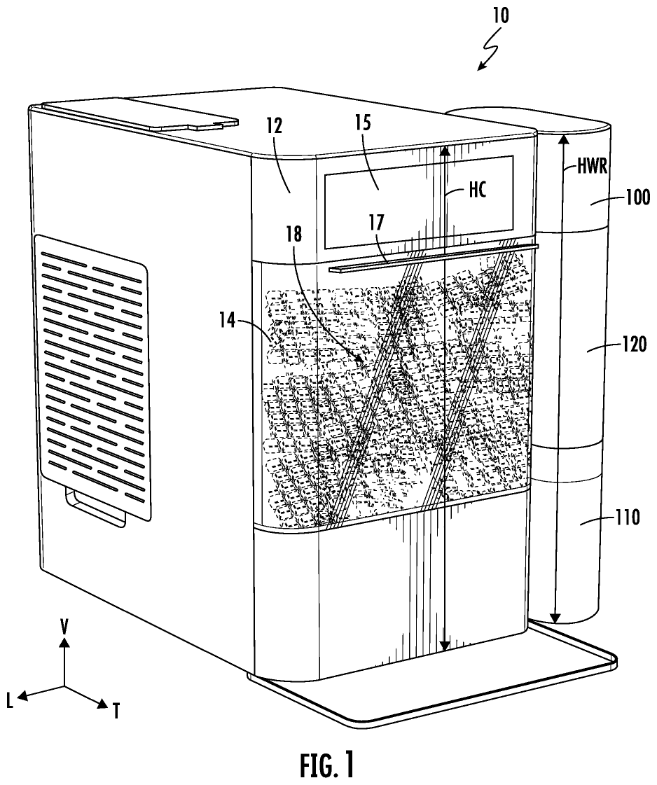

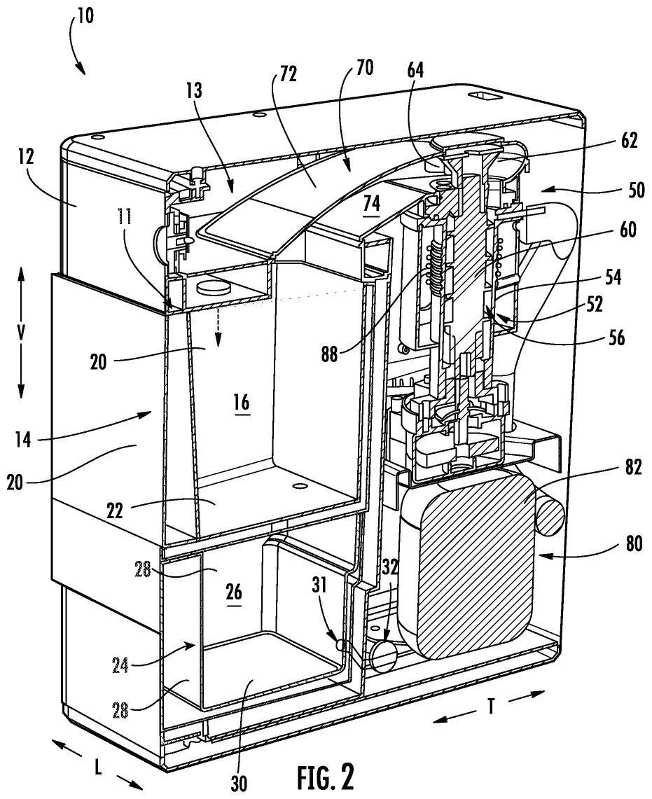

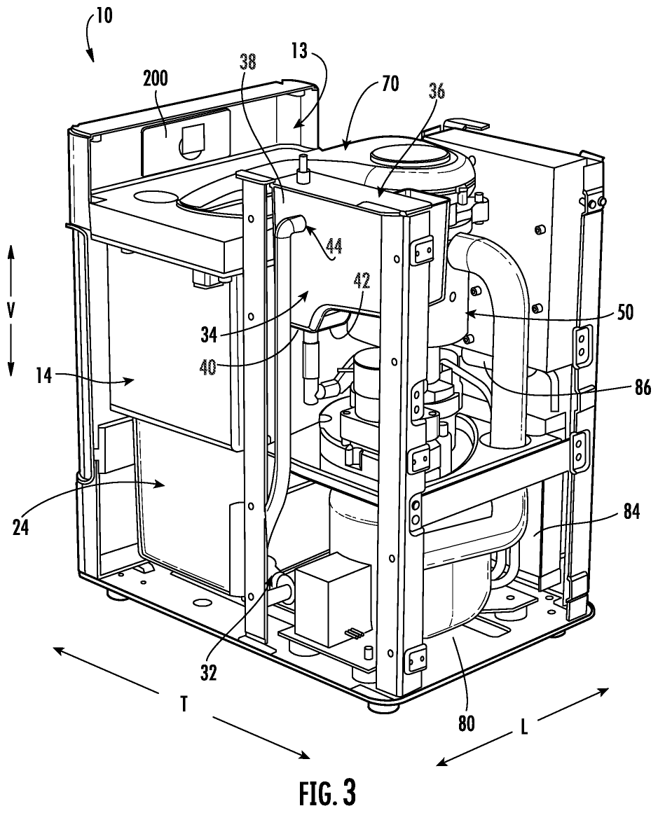

Referring now to FIGS. 1 through 3, one embodiment of an appliance 10 in accordance with the present disclosure is illustrated. As shown, appliance 10 is provided as a stand-alone ice making appliance embodiment. Appliance 10 includes an outer casing 12 which defines a primary opening 11 (e.g., first primary opening) and an internal cavity or volume 13. Internal volume 13 generally at least partially houses various other components of the appliance therein 10. Primary opening 11 defined in outer casing 12 may extend internal volume 13 to an ambient environment. Through primary opening 11, access (e.g., by a user) to the internal volume 13 may be permitted. Outer casing 12 further defines a vertical direction V, a lateral direction L, and a transverse direction T. The vertical direction V, lateral direction L, and transverse direction T are mutually perpendicular and form an orthogonal direction system.

A container 14 of appliance 10 is also illustrated. Container 14 defines a first storage volume 16 for the receipt and storage of ice 18 therein. A user of the appliance 10 may access ice 18 within the container 14 for consumption or other uses, as described in detail below. Container 14 may include multiple walls, including one or more sidewalls 20 and a base wall 22, which may together define the first storage volume 16. In example embodiments, at least one sidewall 20 may be formed in part from a clear, see-through (i.e., transparent, or translucent) material, such as a clear glass or plastic, such that a user can see into the first storage volume 16 and thus view ice 18 therein. For instance, at least one sidewall 20 may include a separate external panel and internal panel formed from a clear, see-through (i.e., transparent, or translucent) material, such as a clear glass or plastic. In some example embodiments, container 14 may include a handle 17. In general, handle 17 may advantageously improve accessibility to ice 18 within container 14. Further, in example embodiments, container 14 may be removable, such as from the outer casing 12, by a user. This facilitates advantageous easy access by the user to ice within the container 14, as discussed below. In general, a user interface 15 may be positioned on casing 12 above container 14. The user interface 15 may generally include input selectors to be selected (e.g., by a user) for controlling the appliance 10.

Appliances 10 in accordance with the present disclosure are advantageously stand-alone appliances, and thus are not connected to refrigerators or other appliances. Additionally, in example embodiments, such appliances are not connected to plumbing or another water source that is external to the appliance 10, such as a refrigerator water source. Rather, in example embodiments, water is initially supplied to the appliance 10 manually by a user, such as by pouring water into water tank 24 and/or an auxiliary reservoir 100. Optionally, in example embodiments, water tank 24 may be removable, such as from the outer casing 12, by a user. This facilitates advantageous easy access by the user to water tank 24 (e.g., in order to easily fill water tank 24), as discussed below.

Notably, appliances 10 as discussed herein include various features which allow the appliances 10 to be affordable and desirable to typical consumers. For example, the stand-alone feature reduces the cost associated with the appliance 10 and allows the consumer to position the appliance 10 at any suitable desired location, with the only requirement in some embodiments being access to an electrical source. In example embodiments, such as those shown in FIGS. 1 through 3, the removable container 14 allows easy access to ice 18 within first storage volume 16 and allows the container 14 to be moved to a different position from the remainder of the appliance 10 for ice usage purposes.

As discussed herein, appliance 10 is configured to make nugget ice, which is becoming increasingly popular with consumers. Ice 18 may be nugget ice. Generally, nugget ice is ice that that is maintained or stored (i.e., in first storage volume 16 of container 14) at a temperature greater than the melting point of water or greater than about thirty-two degrees Fahrenheit. Accordingly, the ambient temperature of the environment surrounding the container 14 may be at a temperature greater than the melting point of water or greater than about thirty-two degrees Fahrenheit. In some embodiments, such temperature may be greater than forty degrees Fahrenheit, greater than fifty degrees Fahrenheit, or greater than sixty degrees Fahrenheit.

Still referring to FIGS. 1 through 3, various components of appliance 10 in accordance with the present disclosure are illustrated. For example, as mentioned, appliance 10 includes a water tank 24. The water tank 24 defines a second storage volume 26 for the receipt and holding of water. Water tank 24 may include multiple walls, including one or more sidewalls 28 and a base wall 30, which may together define the second storage volume 26. In example embodiments, the water tank 24 may be disposed below the container 14 along the vertical direction V defined for the appliance 10, as shown.

As discussed, in example embodiments, water is provided to the water tank 24 for use in forming ice. Accordingly, appliance 10 may further include a pump 32. Pump 32 may be in fluid communication with the second storage volume 26. For example, water may be flowable from the second storage volume 26 through a fluid outlet 31 defined in the water tank 24, such as in a sidewall 28 thereof, and may flow through a conduit to and through pump 32. Pump 32 may, when activated, be operable to actively flow water from the second storage volume 26 therethrough and from the pump 32.

Water actively flowed from the pump 32 may be flowed (e.g., through a suitable conduit) to a reservoir 34. For example, reservoir 34 may define a third storage volume 36. In some embodiments, third storage volume 36 is defined by one or more sidewalls 38 and a base wall 40. Third storage volume 36 may, for example, be in fluid communication with the pump 32 and may thus receive water that is actively flowed from the water tank 24, such as through the pump 32. During operation, water may be flowed into the third storage volume 36 through an opening 44 defined in the reservoir 34.

Referring still to FIGS. 1 through 3, reservoir 34 and third storage volume 36 thereof may receive and contain water to be provided to an ice maker 50 for the production of ice. Accordingly, third storage volume 36 may be in fluid communication with ice maker 50. For example, water may be flowed, such as through an opening 42 and through suitable conduits, from third storage volume 36 to ice maker 50.

Ice maker 50 generally receives water, such as from reservoir 34, and freezes the water to form ice 18. In example embodiments, ice maker 50 is a nugget ice maker, and in particular is an auger-style ice maker, although other suitable styles of ice makers and/or appliances are within the scope and spirit of the present disclosure. As shown, ice maker 50 may include a casing 52 into which water from third storage volume 36 is flowed. Casing 52 is thus in fluid communication with third storage volume 36. For example, casing 52 may include one or more sidewalls 54 which may define an interior volume 56, and an opening may be defined in a sidewall 54. Water may be flowed from third storage volume 36 through the opening (such as via a suitable conduit) into the interior volume 56.

As illustrated, an auger 60 may be disposed at least partially within the casing 52. During operation, the auger 60 may rotate. Water within the casing 52 may at least partially freeze due to heat exchange, such as with a refrigeration system as discussed herein. The at least partially frozen water may be lifted by the auger 60 from casing 52. Further, in example embodiments, the at least partially frozen water may be directed by auger 60 to and through an extruder 62. The extruder 62 may extrude the at least partially frozen water to form ice, such as nuggets of ice 18.

Formed ice 18 may be provided by the ice maker 50 to container 14, and may be received in the first storage volume 16 thereof. For example, ice 18 formed by auger 60 and/or extruder 62 may be provided to the container 14. In example embodiments, appliance 10 may include a chute 70 for directing ice 18 produced by the ice maker 50 towards the first storage volume 16. For example, as shown, chute 70 is generally positioned above container 14 along the vertical direction V. Thus, ice can slide off of chute 70 and drop into storage volume 16 of container 14. Chute 70 may, as shown, extend between ice maker 50 and container 14, and may include a body 72, which defines a passage 74 therethrough. Ice 18 may be directed from the ice maker 50 (such as from the auger 60 and/or extruder 62) through the passage 74 to the container 14. In some embodiments, for example, a sweep 64, which may be connected to and rotate with the auger, may contact the ice emerging through the extruder 62 from the auger 60 and direct the ice 18 through the passage 74 to the container 14.

As discussed, water within the casing 52 may at least partially freeze due to heat exchange, such as with a refrigeration system. In example embodiments, ice maker 50 may include a sealed refrigeration system 80. The sealed refrigeration system 80 may be in thermal communication with the casing 52 to remove heat from the casing 52 and interior volume 56 thereof, thus facilitating freezing of water therein to form ice. Sealed refrigeration system 80 may, for example, include a compressor 82, a condenser 84, a throttling device 86, and an evaporator 88. Evaporator 88 may, for example, be in thermal communication with the casing 52 in order to remove heat from the interior volume 56 and water therein during operation of sealed system 80. For example, evaporator 88 may at least partially surround the casing 52. In particular, evaporator 88 may be a conduit coiled around and in contact with casing 52, such as the sidewall(s) 54 thereof.

It should additionally be noted that, in example embodiments, a controller 200 may be in operative communication with the sealed system 80, such as with the compressor 82 thereof, and may activate the sealed system 80 as desired or required for ice making purposes.

In example embodiments, controller 200 is in operative communication with the pump 32. Such operative communication may be via a wired or wireless connection, and may facilitate the transmittal and/or receipt of signals by the controller 200 and pump 32. Controller 200 may be configured to activate the pump 32 to actively flow water. For example, controller 200 may activate the pump 32 to actively flow water therethrough when, for example, reservoir 34 requires water. A suitable sensor(s), for example, may be provided in the third storage volume 36. The sensor(s) may be in operative communication with the controller 200 and may be configured to transmit signals to the controller 200, which indicate whether or not additional water is desired in the reservoir 34. When controller 200 receives a signal that water is desired, controller 200 may send a signal to pump 32 to activate pump 32.

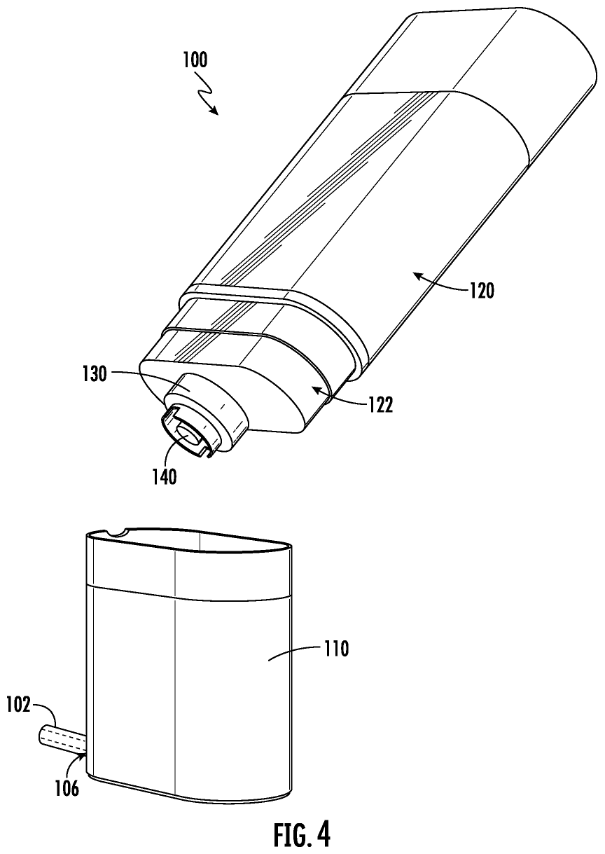

As shown in FIG. 1, appliance 10 may also include an auxiliary water reservoir 100. FIG. 4 also illustrates auxiliary water reservoir 100 according to another example embodiment. Auxiliary water reservoir 100 is described in greater detail below with reference to FIGS. 1 and 4. As may be seen in FIG. 1, a height HWR of auxiliary water reservoir 100 may be about equal to a height HC of casing 12. Thus, the appearance of auxiliary water reservoir 100 may complement casing 12.

Auxiliary water reservoir 100 may be disposed outside of casing 12. For example, auxiliary water reservoir 100 may be mounted at the side of casing 12. Thus, while most components of appliance 10 are housed within casing 12, auxiliary water reservoir 100 is positioned outside of casing 12. In certain example embodiments, auxiliary water reservoir 100 may include a base 110 and a container 120. Base 110 may be attached to casing 12, e.g., at the side of casing 12 adjacent to the bottom of casing 12. For instance, base 110 may be clipped, fastened, etc. to casing 12. As may be seen in FIG. 4, container 120 is removably mounted to base 110. For example, a cap 130 positioned at a bottom portion 122 of container 120 may be received within base 110 to mount container 120 on base 110. A user may lift upwardly on container 120 to remove container 120 from base 110, and the user may insert cap 130 of container 120 into base 110 to mount container 120 on base 110. As an example, the user may remove container 120 from base 110 in order to conveniently fill container 120 with water at a faucet.

Auxiliary water reservoir 100 may be in fluid communication with a water tank within casing 12 such that water within auxiliary water reservoir 100 is flowable to the water tank. For example, a flexible tubing conduit, or a supply line 102, may extend from auxiliary water reservoir 100 to water tank 24, and water from within auxiliary water reservoir 100 may flow from auxiliary water reservoir 100 into second storage volume 26 via supply line 102. It will be understood that appliance 10 may be plumbed in any other suitable manner to deliver water from auxiliary water reservoir 100 into casing 12 for use with ice maker 50 in alternative example embodiments.

Auxiliary water reservoir 100 may include a check valve 140, such as a normally closed check valve. Check valve 140 may be mounted to container 120, e.g., positioned in cap 130 at bottom portion 122 of container 120. Check valve 140 may be configured such that check valve 140 is open when container 120 is mounted to base 110. In addition, check valve 140 may be configured such that check valve 140 is closed when container 120 is removed from base 110. When check valve 140 is open, check valve 140 may allow water within container 120 to flow into base 110. Within base 110, the water may flow to outlet 106 and thus supply line 102, as described above.

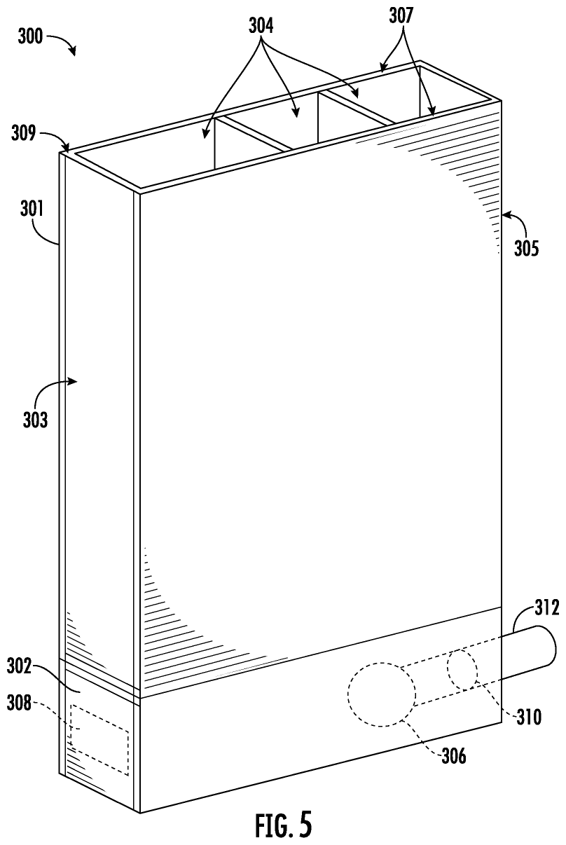

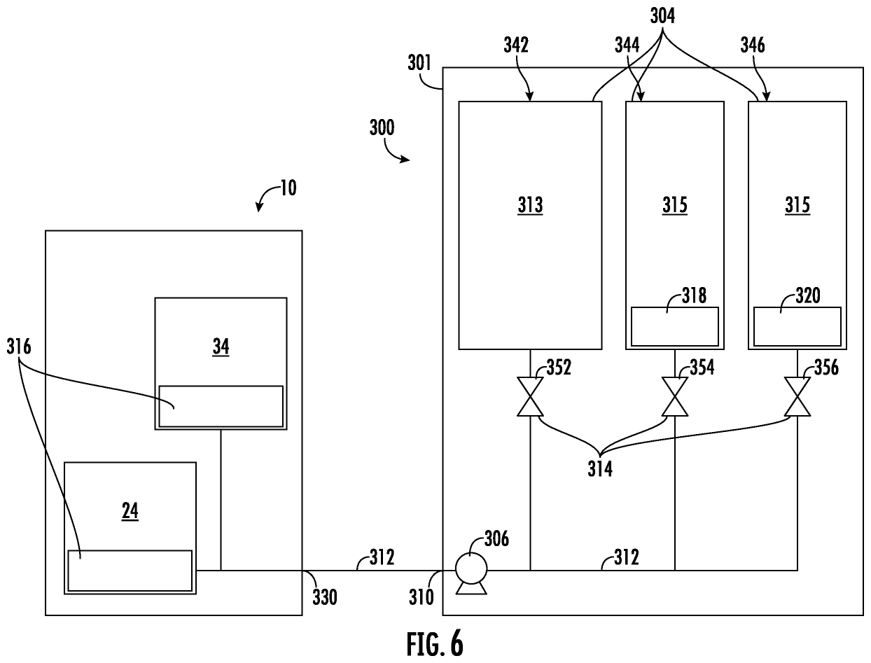

Referring now to FIGS. 5 and 6, provided is a perspective view of a cleaning vessel 300 (FIG. 5) and a side, schematic view of cleaning vessel 300 (FIG. 6) fluidly coupled with appliance 10. The cleaning vessel 300 may generally include a casing 301 defined between a front side 303, a rear side 305, and a pair of sidewalls 307. A lid (not shown) may enclose a top side 309 of casing 301. A user interface 302 may be positioned on casing 301. User interface 302 may generally be configured to receive user inputs to selectively control cleaning vessel 300, as will be explained further hereinbelow. A pump 306 may be disposed within casing 301. Pump 306 may generally be fluidly coupled to a plurality of tanks 304 within casing 301. For example, pump 306 of cleaning vessel 300 may be a dual-direction pump generally configured for operating/pumping fluid in two directions of flow. In the present example embodiment, the plurality of tanks 304 may generally include no less than three tanks within casing 301, as will be further described hereinbelow. A fluid port 310 may be positioned on casing 301 and may generally be fluidly coupled to the plurality of tanks 304.

Moreover, cleaning vessel 300 may include a controller 308 disposed within casing 301. For example, controller 308 may be generally configured to facilitate operation of cleaning vessel 300. In this regard, user interface 302 may be in communication with controller 308 such that controller 308 may receive control inputs from user interface 302 and may otherwise regulate operation of cleaning vessel 300. For example, signals generated by controller 308 may operate cleaning vessel 300, including any or all system components, subsystems, or interconnected devices, in response to the position of user interface 302 and other control commands. Specifically, draining and/or pumping fluid to/from cleaning vessel 300 may occur in response to a user input on user interface 302. For example, the user interface 302 may receive the user input, e.g., a button press, a touch on a touchscreen interface, etc., and the user interface 302 may generate a corresponding signal in response to the user input and such signal may be transmitted to the controller 308. Other components of cleaning vessel 300 may be in communication with controller 308 via, for example, one or more signal lines or shared communication busses. In this manner, Input/Output (“I/O”) signals may be routed between controller 308 and various operational components of cleaning vessel 300.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 308 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 308 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 308 may be operable to execute programming instructions or micro-control code associated with an operating cycle of cleaning vessel 300. In this regard, the instructions may be software or any set of instructions that when executed by the processing device, cause the processing device to perform operations, such as running one or more software applications, displaying a user interface, receiving user input, processing user input, etc. Moreover, it should be noted that controller 308 as disclosed herein is capable of and may be operable to perform any methods, method steps, or portions of methods as disclosed herein. For example, in some embodiments, methods disclosed herein may be embodied in programming instructions stored in the memory and executed by controller 308.

The memory devices may also store data that can be retrieved, manipulated, created, or stored by the one or more processors or portions of controller 308. The data can include, for instance, data to facilitate performance of methods described herein. The data can be stored locally (e.g., on controller 308) in one or more databases and/or may be split up so that the data is stored in multiple locations. In addition, or alternatively, the one or more database(s) can be connected to controller 308 through any suitable network(s), such as through a high bandwidth local area network (LAN) or wide area network (WAN). In this regard, for example, controller 308 may further include a communication module or interface that may be used to communicate with one or more other component(s) of cleaning vessel 300, controller 308, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Referring still to FIG. 6, cleaning vessel 300 may be generally configured to fluidly couple the fluid port 310 of cleaning vessel 300 to a fluid port 330 of the appliance 10 prior to draining and/or pumping fluid to and/or from cleaning vessel 300. For example, hosing 312 may extend between fluid port 310 and fluid port 330. In general, hosing 312 may extend between each tank of the plurality of tanks 304. Additionally, each tank of the plurality of tanks 304 of cleaning vessel 300 may be coupled to a respective valve 314, e.g., a first valve 352 coupled to the first tank 342, a second valve 354 coupled to the second tank 344, a third valve 356 coupled to the third tank 346, etc. Controller 308 may be generally configured to open the respective valve 314 prior to draining and/or pumping fluid to and/or from each tank of the plurality of tanks 304.

As stated above, the plurality of tanks 304 may generally include no less than three tanks within casing 301, e.g., a drain tank (first tank 342), a descale tank (second tank 344), and at least one rinse tank (third tank 346). In an initial state, e.g., prior to use, the drain tank 342 may be empty. In general, the drain tank, of cleaning vessel 300 may define an internal volume 313 between one tenth of a gallon and one and a half gallons, such as between one third of a gallon and one and a quarter gallons, such as between one half of a gallon and a gallon. The drain tank 342 with internal volume 313 may be initially empty, such that the tank 342 may be filled with the drained fluid from appliance 10 while controller 308 operates pump 306 to drain fluid from appliance 10. In general, the other tanks of the plurality of tanks 344, 346 of cleaning vessel 300 may each define an internal volume 315 between one tenth of a gallon and one and a half gallons, such as between two-fifths of a gallon and a gallon, such as between one quarter of a gallon and three-quarters of a gallon of fluid. For example, as seen in FIG. 6, both of the other tanks of the plurality of tanks 304 define internal volume 315. Furthermore, one of the other tanks of the plurality of tanks 304, e.g., descaling tank 344, may be filled with descaling solution, thereby aiding descaling appliance 10 when pumped into it, and the other tank may be a rinse tank, e.g., filled with water or other suitable rinsing fluid. Some example embodiments may include more than one rinse tank, such as two or more rinse tanks 304 in addition to the drain tank 342 (internal volume 313) and descale tank 344 (one of the tanks with internal volume 315).

In other words, the drain tank 342 may define first internal volume 313 which is larger than the internal volume of at least one other tank, such as 250% larger, such as 200% larger, such as 150% larger than the at least one other tank. For example, in some embodiments, the drain tank 342 may define a first internal volume 313 and one or more other tanks, such as every other tank of the plurality of tanks 304, may define second internal volume 315 less than first internal volume 313. In various embodiments, the smaller of the tanks 344, 346 may all have the same internal volume, or, alternatively, the internal volumes of the other tanks of the plurality of tanks 304 may vary.

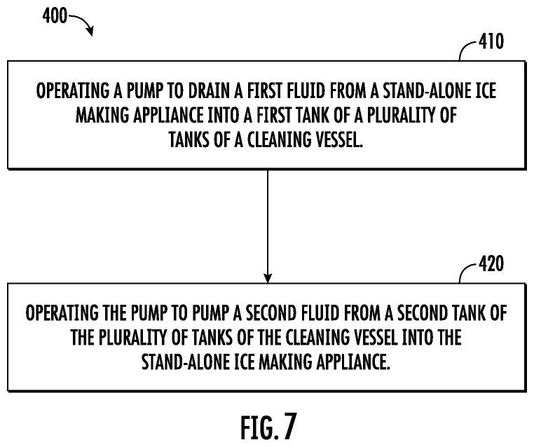

Turning to FIG. 7, a flowchart of an example method (e.g., method 400) of operating cleaning vessel 300 will be described. Although the discussion below refers to the example method 400 of operating cleaning vessel 300, one skilled in the art will appreciate that the example method 400 is applicable to the operation of a variety of other appliances, such as other possible variations of the cleaning vessel. In example embodiments, the various method steps as disclosed herein may be performed (e.g., in whole or part) by controller 308, or another, separate, dedicated controller.

FIG. 7 depicts steps performed in a particular order for the purpose of illustration and discussion. Those of ordinary skill in the art, using the disclosures provided herein, will understand that (except as otherwise indicated) various example methods as may be disclosed herein are not mutually exclusive with each other, e.g., aspects of any one example method may be combined with aspects of any other example method, such that features illustrated or described as part of one embodiment can be used with another embodiment to yield a still further embodiment. Moreover, the steps of method 400 may be modified, adapted, rearranged, omitted, interchanged, or expanded in various ways without deviating from the scope of the present disclosure.

Referring now to FIG. 7, at (410), method 400 may generally include operating pump 306 to drain a first fluid 316 from appliance 10 into a first tank 342 of the plurality of tanks 304 of cleaning vessel 300. Accordingly, step 410 of method 400 may include a plurality of sub-steps. For example, before draining appliance 10, controller 308 may open the first valve 352, e.g., the valve coupled to the first (drain) tank 342. Controller 308 may then activate pump 306 to drain first fluid 316 from appliance 10 into the first tank 342 of the plurality of tanks 304 of cleaning vessel 300. When appliance 10 is drained, pump 306 may be deactivated and the first valve 352 may be closed.

At (420), method 400 may generally include operating pump 306 to pump a second fluid 318 from a second tank 344 of the plurality of tanks 304 of cleaning vessel 300 into appliance 10. Moreover, step 420 of method 400 may include a plurality of sub-steps. For example, controller 308 may open the second valve 354, e.g., the valve coupled to the second (descale) tank 344. Controller 308 may then activate pump 306 to pump second fluid 318 from the second tank 344 of the plurality of tanks 304 of cleaning vessel 300 into appliance 10. In the present example embodiment, second fluid 318 may be any suitable descaling solution, such as vinegar. When appliance 10 is full of second fluid 318, pump 306 may be deactivated and the second valve 354 may be closed. In some example embodiments, a user input on user interface 15 of appliance 10 may be received to begin a cleaning cycle with the second fluid 318. After the cleaning cycle of appliance 10 concludes, second valve 354 may open and pump 306 may be activated to pump second fluid 318 back into the second (descale) tank 344, whereby when appliance 10 is drained of second fluid 318, the second valve 354 may be closed and pump 306 deactivated.

The method may then further include repeating the cleaning operations with the rinse tank 346, or in some example embodiments, repeating the cleaning operations multiple times with a plurality of rinse tanks. For example, the third valve 356, e.g., the valve coupled to the third (rinse) tank 346 may be opened and pump 306 activated to pump a third fluid 320, e.g., the rinse fluid or water, into appliance 10. At this point, after the third fluid 320 is pumped into appliance 10, a user input on user interface 15 of appliance 10 may be received to begin a cleaning cycle with the third fluid 320. After the cleaning cycle of appliance 10 concludes, third valve 356 may open and pump 306 may be activated to pump third fluid 320 back into the third (rinse) tank 346, whereby when appliance 10 is drained of third fluid 320, the third valve 356 may be closed and pump 306 deactivated. Accordingly, the process may be repeated in example embodiments with a fourth tank and fourth valve, fifth tank and fifth valve, sixth tank and sixth valve, etc.

After the rinsing process is complete, a user may detach the hosing 312 from fluid port 330, and dispose of the liquid in each of the plurality of tanks 304 in any suitable water receptacle, such as a kitchen sink, utility sink/tub, or waste water drain. Accordingly, first tank 342 may be empty and ready to repeat method 400 when desired. Additionally, when the user is ready to repeat the descaling process, the other tanks 344, 346 of the plurality of tanks 304 may be re-filled with fresh respective fluids, e.g., new (unused) descale solution in the second tank 344 and new (unused) rinse water in the third tank 346.

As may be seen from the above, an accessory cleaning appliance may be configured to fluidly couple to a stand-alone ice making appliance in order to descale hard mineral deposits. The accessory may include three tanks equipped with valves and may be generally connected to the ice making appliance. The first tank may be configured to drain existing water from the ice making appliance before initiating the descaling process. The second tank may be filled with water mixed with any descaling solution (e.g., vinegar), while the other, third tank may be filled with fresh water for rinsing. During the descaling process, the descaling solution mixed with water (from the second tank) may be circulated inside the ice making appliance to flush out the mineral deposits. The accessory may include a dual-direction positive displacement pump in order to move the fluids from the tanks into the ice making appliance and vice versa. Advantageously, the accessory may be disconnected and drained independently from the ice making appliance after completion of the descaling and rinse cycle(s). As described above, the cleaning appliance may advantageously remove some manual intensity traditionally included in methods of descaling ice making appliances.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cleaning vessel configured to fluidly couple to a stand-alone ice making appliance, the cleaning vessel comprising:
a casing;
a user interface on the casing;
a pump disposed within the casing;
a plurality of tanks within the casing;
a fluid port on the casing, the fluid port fluidly coupled to the plurality of tanks; and
a controller disposed within the casing, the controller configured to:
operate the pump to drain a first fluid from the stand-alone ice making appliance into a first tank of the plurality of tanks of the cleaning vessel; and
operate the pump to pump a second fluid from a second tank of the plurality of tanks of the cleaning vessel into the stand-alone ice making appliance.

2. The cleaning vessel of claim 1, wherein the controller is configured to operate the pump to drain fluid and/or pump fluid in response to a signal from the user interface.

3. The cleaning vessel of claim 1, wherein the fluid port of the cleaning vessel fluidly couples to a fluid port of the stand-alone ice making appliance.

4. The cleaning vessel of claim 1, wherein one tank of the plurality of tanks is filled with descaling solution, thereby aiding descaling the stand-alone ice making appliance when pumped into it.

5. The cleaning vessel of claim 1, wherein one tank of the plurality of tanks is initially empty, such that when fluid drains from the stand-alone ice making appliance, the empty tank may fill with the drained fluid.

6. The cleaning vessel of claim 1, wherein the pump of the cleaning vessel is a dual-direction pump, configured for operating in two directions of flow.

7. The cleaning vessel of claim 1, wherein each tank of the plurality of tanks of the cleaning vessel is coupled to a respective valve, wherein the controller is configured to operate the respective valve when draining and/or pumping fluid to and/or from each tank.

8. The cleaning vessel of claim 1, wherein one tank of the plurality of tanks of the cleaning vessel defines an internal volume between one half of a gallon and a gallon of fluid.

9. The cleaning vessel of claim 8, wherein other tanks of the plurality of tanks of the cleaning vessel each define an internal volume between one quarter of a gallon and three-quarters of a gallon of fluid.

10. A method for operating a cleaning vessel configured to fluidly couple to a stand-alone ice making appliance, the cleaning vessel comprising a casing, a user interface on the casing, a pump disposed within the casing, a plurality of tanks within the casing, a fluid port on the casing, the fluid port fluidly coupled to the plurality of tanks, and a controller disposed within the casing, the method comprising:
operating the pump to drain a first fluid from the stand-alone ice making appliance into a first tank of the plurality of tanks of the cleaning vessel; and
operating the pump to pump a second fluid from a second tank of the plurality of tanks of the cleaning vessel into the stand-alone ice making appliance.

11. The method of claim 10, wherein draining and/or pumping fluid is in response to a user input on the user interface.

12. The method of claim 10, further comprising fluidly coupling the fluid port of the cleaning vessel to a fluid port of the stand-alone ice making appliance prior to draining and/or pumping fluid to and/or from the cleaning vessel.

13. The method of claim 10, wherein one tank of the plurality of tanks is filled with descaling solution, thereby aiding descaling the stand-alone ice making appliance when pumped into it.

14. The method of claim 10, wherein one tank of the plurality of tanks is initially empty, further comprising filling the one tank with the drained fluid while operating the pump to drain fluid from the stand-alone ice making appliance.

15. The method of claim 10, wherein the pump of the cleaning vessel is a dual-direction pump, configured for operating in two directions of flow.

16. The method of claim 10, wherein each tank of the plurality of tanks of the cleaning vessel is coupled to a respective valve, further comprising opening the respective valve prior to draining and/or pumping fluid to and/or from each tank of the plurality of tanks.

17. The method of claim 10, wherein one tank of the plurality of tanks of the cleaning vessel holds between half of a gallon and a gallon of fluid.

18. The method of claim 17, wherein other tanks of the plurality of tanks of the cleaning vessel each hold between quarter of a gallon and three-quarters of a gallon of fluid.
